(19) United States
(12) Patent Application Publication
(10) Pub. No.: US 2003/0135295 A1
(43) Pub. Date: Jul. 17, 2003

(54) Defect source identifier with static manufacturing execution system

(75) Inventors: Amos Dor, Sunnyvale, CA (US); Yifah Gavra, Los Altos, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/047,781

(22) Filed: Jan. 14, 2002

(51) Int. Cl. G06F 19/00

(52) U.S. Cl. 700/108; 700/110; 700/109; 700/117; 700/121

(57) ABSTRACT

A defect source identifier that provides information used to identify a source of a defect on a substrate, which defect source identifier includes a LotRoute database generation process and a LotRoute database access process, wherein the LotRoute database generation process includes a software application that runs on a server and that, in response to user input, defines a wafer route including wafer route information, and associates the wafer route with any one of a number of entities; and the LotRoute database process includes a software application that runs on the server and that, in response to input from the defect source identifier, retrieves the wafer route information using an identifier of one of the entities.

### TECHNICAL FIELD OF THE INVENTION

The present invention relates to method and apparatus for analyzing defects that occur in processing substrates to manufacture structures such as integrated circuits, optical components, and so forth.

### BACKGROUND OF THE INVENTION

Defects may occur at any stage of processing substrates (for example, semiconductor wafers) to form structures such as integrated circuits, optical components, and so forth. Generally each integrated circuit manufacturer maintains a proprietary database of sources or causes of defects that occur on a sufficiently frequent basis. In particular, if a defect occurs frequently, the database may contain a description of the defect, a source or cause of the defect, and a solution, i.e., a method to prevent the defect from recurring. For example, certain defects may occur whenever a specific semiconductor processing chamber becomes dirty. For such defects, the database might contain a solution indicating that one ought to execute a cleaning cycle for the specific semiconductor processing chamber.

To identify defects, wafers are selected from a lot of wafers that is being processed, for example, one in every N wafers is selected. Typically, the selected wafers are inspected by tools (commonly referred to as inspection/review tools) that produce images, data, and other information relating to the selected wafers. Output from the tools may be analyzed using one or more defect analysis techniques. In accordance with one method of identifying defects, a skilled operator reviews images and data output from the inspection/review tools and/or the defect analysis techniques to identify defects on the selected wafers, and to determine a source of the identified defects. In accordance with another method of identifying defects, a defect source identifier (“DSI”), for example, a defect source identification application residing, for example and without limitation, on a server, receives defect information from various sources, for example and without limitation, from inspection/review tools. In addition, the DSI might have access to a defect knowledge library (“DKL”), for example, a defect knowledge library application, that comprises a database residing, for example and without limitation, on the same server. Lastly, the DSI might use route information from a manufacturing execution system (“MES”) to correlate the defect information with a route of the selected wafers through various semiconductor processing systems and various inspection/review tools.

There is a need in the art for analyzing defects to determine sources of the defects, and to provide defect solutions whenever route information is not available from the MES.

### SUMMARY OF THE INVENTION

One or more embodiments of the present invention satisfy the above-identified need in the art. In particular, one embodiment of the present invention is a defect source identifier that provides information used to identify a source of a defect on a substrate, which defect source identifier comprises a LotRoute database generation process and a LotRoute database access process, wherein the LotRoute database generation process comprises a software application that runs on a server and that, in response to user input, defines a wafer route including wafer route information, and associates the wafer route with any one of a number of entities; and the LotRoute database process comprises a software application that runs on the server and that, in response to input from the defect source identifier, retrieves the wafer route information using an identifier of one of the entities.

### BRIEF DESCRIPTION OF THE DRAWING

FIG. 1 is a block diagram that includes one embodiment of a defect source identifier (“DSI”) that is fabricated in accordance with one embodiment of the present invention; and

FIGS. 2-4 show graphical user interface screens that are fabricated in accordance with one or more embodiments of the present invention, which screens may be displayed on a user display apparatus associated with the DSI shown in FIG. 1.

### DETAILED DESCRIPTION

The following includes: (a) first, a brief description of a defect source identifier (“DSI”) that has access to a manufacturing execution system (“MES”); and (b) second, a description of a static MES (“SMES”) that is fabricated in accordance with one or more embodiments of the present invention. As will be described in detail below, an SMES is a tool that enables users of the DSI to recreate at least some of the functionality of the MES. Advantageously, the SMES may be used, for example and without limitation, whenever connectivity to an MES is not possible, or is disabled.

DSI:

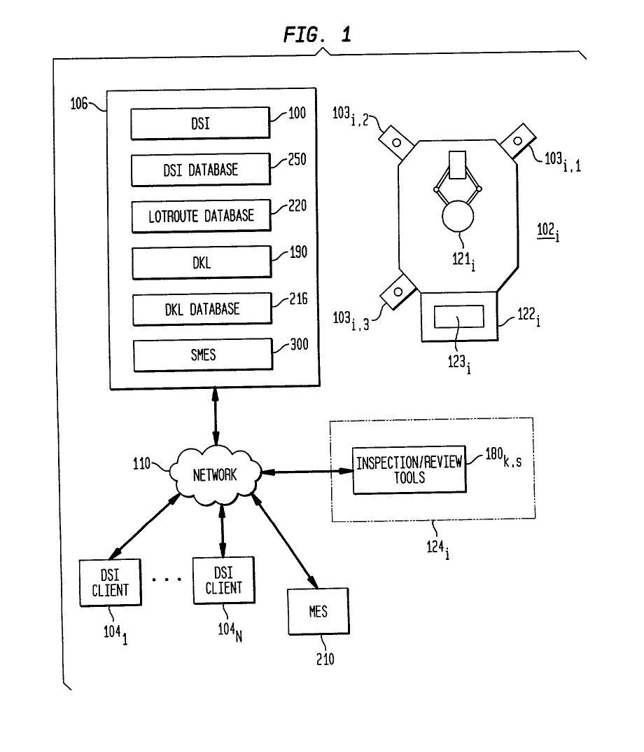

FIG. 1 shows one embodiment of defect source identifier 100 (“DSI 100”) that helps users, for example, a fab yield group, identify sources of defects on substrates or wafers processed by wafer processing systems such as, for example, wafer processing system 102ᵢ. In general, DSI 100 may be used to identify sources of defects on semiconductor wafers or on substrates of any kind (for example and without limitation, substrates upon which integrated circuits or other structures, for example, optical components, are fabricated).

As shown in FIG. 1, DSI 100 is an application that runs, for example, on DSI server 106, and is coupled to: (a) defect source identifier clients 104_{1-N} (“DSI clients 104_{1-N}”) through network 110; (b) one or more of inspection/review tools 180_{j,s} of inspection/review cell 124ⱼ through network 110; (c) defect knowledge library 190 (“DKL 190”) which is an application that runs, for example, on DSI server 106; and (d) manufacturing execution system (“MES 210”) through network 110. In accordance with one embodiment, DSI server 106 is a network server such as a WINDOWS NT® server. Further, network 110 may comprise the Internet, an intranet, a wide area network (WAN), or any other form of a network.

As shown in FIG. 1, wafer processing system 102ᵢ comprises one or more process cells 103_{i,j}, wafer transfer system 121ᵢ, and factory interface 122ᵢ. Each one of process cells 103_{i,j} is configured to perform a process on a wafer such as, for example, and without limitation, a chemical vapor deposition (CVD) process, a physical vapor deposition (PVD) process, an electrochemical plating (ECP) process, and so forth. Factory interface 122ᵢ includes cassette loadlock 123ₗ. Cassette loadlock 123ᵢ stores one or more wafer cassettes, and individual wafers are moved from cassette loadlock 123ᵢ to process cells 103_{i,j} by wafer transfer system 121ₗ. Inspection/review cell 124ₖ comprises one or more inspection/review tools 180_{k,s}. that perform inspection/review processes on wafers, for example, wafers processed by wafer processing system 102ᵢ (it should be understood that one inspection/review cell may receive wafers processed by several processing tools, and that wafers may be processed by inspection/review tools in several inspection/review cells). Inspection/review tools 180_{k,s} measure and test wafer characteristics and wafer defects, and in general, inspection/review tools 180_{k,s} may include any form of instrument, equipment, or process (either in combination or individually) that facilitates identification of defects on a wafer or defects in an integrated circuit formed on the wafer (generally referred to herein as defects or wafer defects interchangeably). In particular, inspection/review tools 180_{k,s} may include, for example, a scanning electron microscope, and an optical wafer defect inspection system.

As shown in FIG. 1, DSI 100 interacts with one or more of inspection/review tools 180_{k,s} of inspection/review cell 124ₖ through network 110 to collect defect information. Defect images output from a optical wafer defect inspection system and/or a scanning electron microscope (or applications associated with them) include defect information in the form of, for example, a KLA file (referring to KLA-TENCOR® of San Jose, Calif.) or a KLA result file (KLARF) that can: (a) be stored by DSI 100 in DSI database 250; (b) utilized by DSI 100; and (c) utilized by, and/or displayed to, users located at DSI client 104ᵢ.

In accordance with one embodiment, defect information (in the form of defect images, data, or other information) is stored in DSI database 250, and, DSI 100 analyzes the defect information to determine, or to help determine, the source or cause of the defect. For example, DSI 100 may utilize such images, data, and other recently collected information during repetitive wafer defect analysis of one or more wafers. Such repetitive wafer defect analysis may be utilized to provide defect repeater information and adder information. DSI 100 may also utilize the defect information to provide cluster information (where multiple instances of a defect occur within a region). In accordance with such one embodiment, DSI 100 may gather defect attributes such as adders, repeaters, and cluster information in near real-time. Further, in accordance with one such embodiment, DSI 100 may display possible sources, and/or display an operational solution that remedies a process situation in wafer processing system 102ᵢ that caused the defect. For example, such an operational solution may entail carrying out a predetermined cleaning procedure on one of the processing chambers of wafer processing system 102ᵢ.

In accordance with one embodiment, DSI 100 may access DKL 190. DKL 190 may store and access images, data, and other information obtained from a variety of sources relating to historical wafer defect case histories that are used to help analyze defect information generated by wafers processed in wafer processing system 102ᵢ (such information may be stored, for example, in DKL database 216). One or more embodiments of DSI 100 may compare wafer images with case histories of wafer defects to help identify sources of defects, and to help identify operational solutions to prevent recurrence of the defects, i.e., DSI 100 may match defect information relating to current defects occurring in wafer processing system 102ᵢ with previously collected defect information. In addition, DSI 100 may access DKL 190 to obtain a list of sources or causes for each detected defect.

In accordance with one embodiment, DSI client 104ᵢ is a web client application that runs, for example, on an enduser computer, and interacts with DSI 100 through network 110. Network 110 may utilize computer languages utilized, for example, by the Internet such as Hypertext Markup Language (HTML) or eXtensible Markup Language (XML). The use of HTML and/or XML may entail use of a HTML and/or XML browser, respectively, installed at each enduser computer. Further, in accordance with one such embodiment, DSI client 104ᵢ may interact with DSI 100 to retrieve data from DSI database 250 and DKL database 216 (by way of DKL 190) that relate to present and historical (i.e., case studies) defects on wafers, respectively. Further, DSI client 104ᵢ may interact with DSI 100 to help identify sources of defects, and to provide operational solutions to prevent recurrence of such defects. In accordance with certain embodiments of DSI 100, potential solutions to causes of the defect are investigated by a yield group, and then are entered into DKL database 216 (by way of DKL 190) using DSI client 104ᵢ.

In accordance with one or more embodiments, graphical user interface (GUI) displays are provided at DSI client 104ᵢ. These GUI displays provide interactivity for a user with DSI 100. For example, in accordance with one such embodiment, DSI client 104ᵢ includes a display to view defect images referenced by KLA files produced by the inspection/review tools. In addition, in accordance with one such embodiment, wafer defect case histories can be displayed on the display. In further addition, in accordance with one such embodiment, an image from a current defect may be displayed on the display beside an image of a case study defect (a reference image) for comparison purposes. In still further addition, in accordance with one such embodiment, a wafer map image may be created and displayed to indicate visually locations of defects on the wafer.

As shown in FIG. 1, DSI 100 interacts with MES 210. One embodiment of MES 210 includes a WORKSTREAM® manufacturing execution system manufactured by CONSILIUM® of Mountain View, Calif. MES 210, among other things, is an application that controls flow routes of wafer lots utilized during a manufacturing process. In accordance with one embodiment, DSI 100 gathers lot routing information from MES 210 in near real-time. For example, DSI 100 may interact with MES 210 to populate fields of LotRoute database 220, which fields can be used by DSI 100 for automatic processing, or which fields can be displayed to a user. For example, in accordance with one such embodiment, the following information is used to identify and extract data from MES 210: (a) ToolType (for example, optical wafer defect inspection system or scanning electron microscope); (b) Tool ID (unique inspection/review tool identification); (c) Date; and (d) Lot ID. In response, the following information may be output from MES 210: (a) Wafer ID; (b) Lot ID; (c) Date; (d) List of tools (an ordered list of processing tools that processed the wafer before the testing tool—for example, if multiple processing tools are used, the processing tools are listed from first to last). In accordance with one such embodiment, the processing tools can be selected to view case studies that apply to a specific defect, or to a class of defects caused by selected process tools. This helps DSI 100 and/or a user using DSI client 104ᵢ to identify which processing tools may be a source of a defect.

SMES:

SMES is a tool or a software application that includes an SMES LotRoute database generation process and an SMES LotRoute database process. As shown in FIG. 1, in accordance with one embodiment of the present invention, SMES 300 is a software application that runs on DSI server 106. The SMES LotRoute database generation process may be utilized by a user of DSI 100 to recreate at least some of the functionality provided by MES 210. In accordance with one embodiment of the present invention, the SMES LotRoute database generation process enables a user to define wafer route information, and to associate it with any one of a number of entities. In one such embodiment, a user may define wafer route information and associate it with one of four (4) entities: (a) Lot ID; (b) Step or Layer ID; (c) Inspection/Review Tool ID; and (d) a Fixed Route.

In accordance with one embodiment of the present invention, the SMES database process may be utilized by DSI 100, for example and without limitation, whenever connectivity to MES 210 is not possible, or is disabled, to provide information. However, in a typical case, when DSI 100 is configured, it is known whether or not DSI 100 will be connected to MES 210. If not, DSI 100 may be referred to as a “standalone” system. In such a case, DSI 100 will be configured to invoke the SMES database process whenever DSI 100 needs to access, for example, route information using MES 210. In accordance with an alternative embodiment of the present invention, the SMES database process may be invoked by DSI 100 whenever DSI 100 attempts to access, for example, route information from MES 210, and DSI 100 finds that it cannot do so. Thereafter, whenever DSI 100 needs to access route information from MES 210, it will interface with the SMES database process instead. In accordance with a further such embodiment of the present invention, DSI 100 may periodically attempt to reconnect to MES 210.

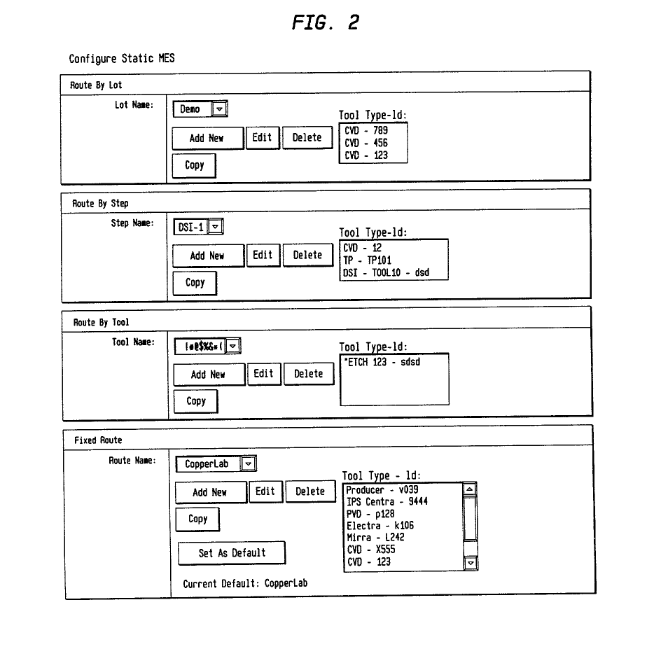

FIGS. 2-4 show graphical user interface (UI) screens that are fabricated in accordance with one embodiment of the present invention, which screens may be displayed on a user display apparatus associated with DSI 100, for example, using network 110. In order to supply information to the SMES database generation process, a user of DSI 100 will utilize a user interface related to the SMES database generation process to define routes for process wafers. FIG. 2 shows a UI screen entitled “Configure Static MES.”

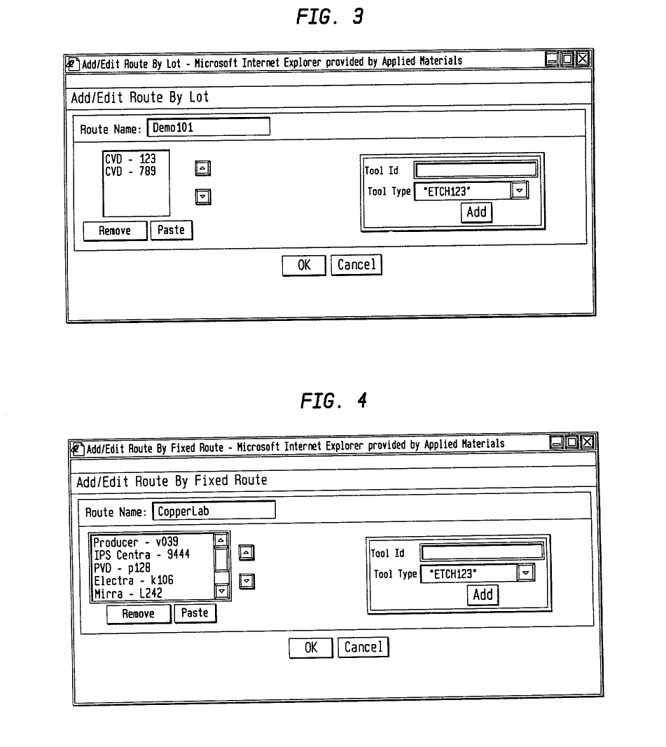

By selecting a portion of the UI screen entitled “Route By Lot”, a lot name can be associated with a single route. For this case, the user can add a new route, edit an existing route, delete an existing route, or copy an existing route. The user may elect to add a new route by “mouse clicking” the tab entitled “Add New”. In response, a pop-up screen may appear, like that shown in FIG. 3. The user will then enter the lot name in an input space next to “Route Name”. The SMES database generation process will then determine whether the lot name is unique for the “Route By Lot” file. Next, the user will: (a) enter a Tool Id in an input space next to “Tool Id”; (b) enter a Tool Type in an input space next to “Tool Type”; and (c) “mouse click” on a tab entitled “Add”. This last step is repeated to generate the route. If the user is satisfied with the route information, the user will complete the operation by “mouse clicking” a tab entitled “OK”. In response, the SMES database generation process will create an entry in LotRoute database 220 (for example, in a table or file) to store the information. For this case, LotRoute database 220 may be accessed using the Lot ID as a retrieval key.

Returning to FIG. 2, to find existing routes by lot, the user can “mouse click” the “down arrow” next to an input space” adjoining “Lot Name” (i.e., by using a “drop-down” menu). The user may elect to edit an existing route by finding the existing route (see above), and then by “mouse clicking” a tab entitled “Edit”. In response, a pop-up screen may appear, like that shown in FIG. 3. Tools in the existing route will be shown in a space above tabs entitled “Remove” and “Paste”. The user can remove tools from the route, and paste a copy of an entire route at the end of the list by appropriately “mouse clicking” on the “up arrow”, “down arrow”, “Remove” and “Paste” tabs shown in FIG. 3. Further, by appropriate juxtaposition of these operations, the user can rearrange the route, i.e., change the order of the tools for the route. Finally, when the user is satisfied with the route information, the user will complete the operation by “mouse clicking” the tab entitled “OK”.

Returning to FIG. 2 again, the user may elect to delete an existing route by finding the existing route (see above), and then by “mouse clicking” a tab entitled “Delete”. Lastly, the user may elect to copy an existing route by finding the existing route (see above), and then by “mouse” clicking a tab entitled “Copy”.

By selecting a portion of the UI screen shown in FIG. 2 entitled “Route By Step”, the user may associate an inspection step with a single route. For this case, the user may add a new route, edit an existing route, delete an existing route, or copy an existing route in a manner that is substantially the same as that described above for the Route By Lot. For example, for the case of adding a new route, the user will input information relating to all tools for the route that goes through that inspection step. In response, the SMES database generation process will create an entry in LotRoute database 220 to store the information. For this case, LotRoute database 220 may be accessed using the Step ID as a retrieval key.

By selecting a portion of the UI screen shown in FIG. 2 entitled “Route By Tool”, the user may associate an inspection tool with a single route. For this case, the user can add a new route, edit an existing route, delete an existing route, or copy an existing route in a manner that is substantially the same as that described above for the Route By Lot. For example, for the case of adding a new route, the user will input information relating to all tools for the route that goes through that inspection tool/review tool. In response, the SMES database generation process will create an entry in LotRoute database 220 to store the information. For this case, LotRoute database 220 may be accessed using the Inspection Tool/Review Tool ID as a retrieval key.

By selecting a portion of the UI screen shown in FIG. 2 entitled “Fixed Route”, the user can define routes that are not associated with Lot Name, Step Name, or Inspection/Review Tool. This enables the user to choose one route as a default route whenever query data cannot be matched with existing lot/step/tool data. For this case, the user can add a new route, edit an existing route, delete an existing route, or copy an existing route in a manner that is substantially the same as that described above for the Route By Lot in conjunction with FIG. 4. As a result, for the case of adding a new route, the user will input information relating to all tools for the route. Lastly, the user can set the Default route by finding an existing route (see above), and then by “mouse clicking” a tab “Set As Default” in FIG. 2. The current default will be displayed next to “Current Default:”.

Many methods are well known to those of ordinary skill in the art for embodying UI screens shown in FIG. 2-4, and for obtaining inputs provided by users that utilize these screens. Further, many methods are well known to those of ordinary skill in the art for embodying the SMES database generation process to create LotRoute database 220.

In use, whenever DSI 100 interfaces with the SMES database process to fetch wafer route information, the SMES database process will search for the route information, trying first to identify the route using Lot ID as a retrieval key. If the specified lot does not exist in LotRoute database 220, the SMES database process will search for the route information using Step ID as a retrieval key, and then using Inspection Tool/Review Tool ID as a retrieval key. If all of the above searches fail, the SMES database process will use the default lot route. Thus, the algorithm for responding to a query to retrieve wafer route information from LotRoute database 220 is given as follows. Step a, search for a route using Lot ID. If a route associated with the Lot ID is found, return the route information, otherwise go to Step b. Step b, search for the route using Step ID, if specified. If a route associated with the Step ID is found, return the route information, otherwise go to Step c. Step c, search for the route using Tool ID, if specified. If a route associated with the Tool ID is found, return the route information, otherwise go to Step d. Step d, return the default route. Many methods are well known to those of ordinary skill in the art embodying the above-described database query process. In accordance with an alternative embodiment, a Lot ID, a Step ID, and a Tool ID are input together as a single query, and the search proceeds as outlined above.

In accordance with one embodiment of the present invention, the route information output from the SMES database process will be provided as (Tool Type, Tool ID) for each tool associated with a route in order of use.

Although various embodiments that incorporate the teachings of the present invention have been shown and described in detail herein, those skilled in the art can readily devise many other varied embodiments that still incorporate these teachings.

What is claimed is:

1. A defect source identifier that provides information used to identify a source of a defect on a substrate, which defect source identifier comprises:
a LotRoute database generation process and a LotRoute database access process, wherein:
the LotRoute database generation process comprises a software application that runs on a server and that, in response to user input, defines a wafer route including wafer route information, and associates the wafer route with any one of a number of entities; and
the LotRoute database process comprises a software application that runs on the server and that, in response to input from the defect source identifier, retrieves the wafer route information using an identifier of one of the entities.

2. The defect source identifier of claim 2 wherein the entities are one of Lot ID, Step or Layer ID, Inspection/Review Tool ID, and Fixed Route ID.

3. The defect source identifier of claim 2 wherein the LotRoute database generation process designates the wafer route associated with the Route ID as a default route.

4. The defect source identifier of claim 3 wherein the wafer route information associated with an entity comprises one or more tools specified by one or more of tool type and tool identifier.

5. The defect source identifier of claim 4 wherein the LotRoute database generation process enables a user to add, edit, or delete a wafer route.

6. The defect source identifier of claim 5 wherein the LotRoute database process comprises a retrieval algorithm that retrieves wafer route information by searching for a wafer route using Lot ID as a retrieval key, and if a wafer route associated with the Lot ID is found, returning the wafer route information; otherwise by searching for the wafer route using Step ID as a retrieval key, if specified, and if a wafer route associated with the Step ID is found, returning the wafer route information, otherwise by searching for the wafer route using Tool ID as a retrieval key, if specified, and if a wafer route associated with the Tool ID is found, returning the wafer route information, otherwise by returning the default wafer route information.
